(19) United States
(12) Patent Application Publication
(10) Pub. No.: US 2026/0287880 A1
(43) Pub. Date: Sep. 24, 2026

(54) OPTICAL SYSTEM

(71) Applicant: Asia Optical Co., Inc., Taichung (TW)

(72) Inventors: Yao Pei, ShenZhen City (CN); Fang-Li Ma, ShenZhen City (CN); Yue-Ye Chen, ShenZhen City (CN); Hua-Tang Liu, Taichung (TW)

(21) Appl. No.: 19/531,872

(22) Filed: Feb. 6, 2026

(30) Foreign Application Priority Data
Mar. 19, 2025 (CN) 202510329305.5

(51) Int. Cl. G02B 23/02; G02B 3/00; G02B 7/02; G02B 25/00

(52) U.S. Cl. CPC G02B 23/02; G02B 7/025; G02B 25/001; G02B 2003/0093

(57) ABSTRACT

An optical system includes an optical module. The optical module is with positive refractive power and includes a first lens, a second lens, and a third lens. The first lens is with refractive power and includes a convex surface facing an object side. The second lens is with refractive power. The third lens is a biconcave lens with negative refractive power and includes a concave surface facing the object side and another concave surface facing an image side. The first lens, the second lens, and the third lens are arranged in order from the object side to the image side along an optical axis.

### BACKGROUND OF THE INVENTION

### Field of the Invention

The invention relates to an optical system.

### Description of the Related Art

In order to meet the requirements of diverse observation scenes, modern telescopes often have an adjustable magnification, known as zoom telescopes. However, traditional zoom telescopes experience significant image quality degradation at high magnification ratio, making them inadequate for today's requirements. Therefore, an optical system needs a new structure in order to simultaneously increase the magnification ratio and maintain high image quality.

### BRIEF SUMMARY OF THE INVENTION

The invention provides an optical system to solve the above problems. The optical system can further increase the magnification ratio of the entire telescope and maintain good optical performance, when used with a telescope.

The optical system in accordance with an exemplary embodiment of the invention includes an optical module. The optical module is with positive refractive power and includes a first lens, a second lens, and a third lens. The first lens is with refractive power and includes a convex surface facing an object side. The second lens is with refractive power. The third lens is a biconcave lens with negative refractive power and includes a concave surface facing the object side and another concave surface facing an image side. The first lens, the second lens, and the third lens are arranged in order from the object side to the image side along an optical axis. The optical module satisfies at least one of the following conditions: 5×10⁻⁶≤fLG1/fLGM≤2×10⁻⁴; 39000≤fLGM/dLG1LG2≤83000; 0.8≤DLG1/DLG2≤1.2; 0.3 mm⁻¹≤(R12LG2/R11LG1)/MLGM≤4.2 mm⁻¹; wherein fLG1 is a combined effective focal length of the first lens and the second lens, fLGM is an effective focal length of the optical module, R12LG2 is a radius of curvature of an image side surface of the third lens, R11LG1 is a radius of curvature of an object side surface of the first lens, dLGILG2 is an interval from the object side surface of the first lens to the image side surface of the third lens along the optical axis, DLG1 is an effective optical diameter of the first lens, DLG2 is an effective optical diameter of the third lens, and MLGM is a variable magnification of the optical module.

In another exemplary embodiment, there is no air gap between the first lens and the second lens, and the optical system satisfies the condition: −1.6≤(R11LG2+R12LG2)/R11LG1≤4.7; wherein R11LG2 is a radius of curvature of an object side surface of the third lens, R12LG2 is the radius of curvature of the image side surface of the third lens, and R11LG1 is the radius of curvature of the object side surface of the first les.

The optical system in accordance with another exemplary embodiment of the invention includes an optical module. The optical module is with positive refractive power and consists of three or four lenses. The optical module includes a first lens, a second lens, and a third lens, and there is no air gap between the first lens and the second lens. The first lens is with refractive power and includes a convex surface facing an object side. The second lens is with refractive power. The third lens is a biconcave lens with negative refractive power and includes a concave surface facing the object side and another concave surface facing an image side. The first lens, the second lens, and the third lens are arranged in order from the object side to the image side along an optical axis.

In another exemplary embodiment, the optical module satisfies at least one of the following conditions: 5×10⁻⁶≤fLG1/fLGM≤2×10⁻⁴; −1.6≤(R11LG2+R12LG2)/R11LG1≤4.7; 39000≤fLGM/dLG1LG2≤83000; 0.8≤DLG1/DLG2≤1.2; 0.3 mm⁻¹≤R12LG2/R11LG1/MLGM≤4.2 mm⁻¹; wherein fLG1 is a combined effective focal length of the first lens and the second lens, fLGM is an effective focal length of the optical module, R11LG2 is a radius of curvature of an object side surface of the third lens, R12LG2 is a radius of curvature of an image side surface of the third lens, R11LG1 is a radius of curvature of an object side surface of the first lens, dLG1LG2 is an interval from the object side surface of the first lens to the image side surface of the third lens along the optical axis, DLG1 is an effective optical diameter of the first lens, DLG2 is an effective optical diameter of the third lens, and MLGM is a variable magnification of the optical module.

In yet another exemplary embodiment, the first lens is a biconvex lens with positive refractive power and further includes another convex surface facing the image side; and the second lens is with negative refractive power and includes a concave surface facing the object side.

In another exemplary embodiment, the optical system further includes a fourth lens disposed between the second lens and the third lens, wherein the fourth lens is a meniscus lens with positive refractive power and includes a concave surface facing the object side and a convex surface facing the image side.

In yet another exemplary embodiment, the second lens is a biconcave lens and includes a concave surface facing the image side.

In another exemplary embodiment, the second lens includes a plane surface facing the image side.

In yet another exemplary embodiment, the optical system further includes an objective lens module and an eyepiece module, wherein the objective lens module is disposed between the optical module and the eyepiece module, the eyepiece module is disposed between the objective lens module and the image side, the optical module, the objective lens module, and the eyepiece module are arranged in order from the object side to the image side along the optical axis, an effective focal length of the objective lens module is greater than an effective focal length of the eyepiece module, an effective optical diameter of the objective lens module is greater than an effective optical diameter of the eyepiece module, and the optical system satisfies at least one of the following conditions: 0 mm<dLG2L5≤30 mm; 6≤fLGOBJ/fLGEYE≤10; wherein dLG2L5 is an interval from the image side surface of the third lens to a lens of the objective lens module closest to the object side along the optical axis, fLGOBJ is the effective focal length of the objective lens module, and fLGEYE is the effective focal length of the eyepiece module.

In another exemplary embodiment, the optical system further includes an objective lens module, a prism module, and an eyepiece module, all of which are arranged in order from the object side to the image side along the optical axis, wherein the objective lens module, the prism module, and the eyepiece module are disposed between the optical module and the image side, the objective lens module includes a fifth lens, a sixth lens, a seventh lens, and an eighth lens, the fifth lens is with positive refractive power, the sixth lens is with negative refractive power, the seventh lens is with positive refractive power, and the eighth lens is with negative refractive power, the prism module includes a first prism and a second prism, the eyepiece module includes a ninth lens, a tenth lens, an eleventh lens, and a twelfth lens, wherein the ninth lens is with negative refractive power, the tenth lens is with positive refractive power, the eleventh lens is with positive refractive power, and the twelfth lens is with positive refractive power, the fifth lens, the sixth lens, the seventh lens, the eighth lens, the first prism, the second prism, the ninth lens, the tenth lens, the eleventh lens, and the twelfth lens are arranged in order from the object side to the image side along the optical axis, the fifth lens and the sixth lens are cemented, or there is no air gap between the fifth lens and the sixth lens, the ninth lens and the tenth lens are cemented, or there is no air gap between the ninth lens and the tenth lens, the fifth lens is a biconvex lens and includes a convex surface facing the object side and another convex surface facing the image side, the sixth lens is a meniscus lens and includes a concave surface facing the object side and a convex surface facing the image side, the seventh lens is a meniscus lens and includes a convex surface facing the object side and a concave surface facing the image side, the eighth lens is a meniscus lens and includes a convex surface facing the object side and a concave surface facing the image side, the ninth lens is a biconcave lens and includes a concave surface facing the object side and another concave surface facing the image side, the tenth lens is a biconvex lens and includes a convex surface facing the object side and another convex surface facing the image side, the eleventh lens is a meniscus lens and includes a convex surface facing the object side and a concave surface facing the image side, and the twelfth lens is a meniscus lens and includes a convex surface facing the object side and a concave surface facing the image side.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout diagram of an optical system in accordance with a first embodiment of the invention;

FIG. 2 depicts a longitudinal aberration diagram of the optical module of the optical system in accordance with the first embodiment of the invention;

FIG. 3 is a field curvature and a distortion diagrams of the optical module of the optical system in accordance with the first embodiment of the invention;

FIG. 4 is a lateral color diagram of the optical module of the optical system in accordance with the first embodiment of the invention;

FIG. 5 is a modulation transfer function diagram of the optical module of the optical system in accordance with the first embodiment of the invention;

FIG. 6 depicts a longitudinal aberration diagram of the optical system in accordance with the first embodiment of the invention;

FIG. 7 is a field curvature and a distortion diagrams of the optical system in accordance with the first embodiment of the invention;

FIG. 8 is a lateral color diagram of the optical system in accordance with the first embodiment of the invention;

FIG. 9 is a modulation transfer function diagram of the optical system in accordance with the first embodiment of the invention;

FIG. 10 is a lens layout diagram of an optical system in accordance with a second embodiment of the invention;

FIG. 11 depicts a longitudinal aberration diagram of the optical module of the optical system in accordance with the second embodiment of the invention;

FIG. 12 is a field curvature and a distortion diagrams of the optical module of the optical system in accordance with the second embodiment of the invention;

FIG. 13 is a lateral color diagram of the optical module of the optical system in accordance with the second embodiment of the invention;

FIG. 14 is a modulation transfer function diagram of the optical module of the optical system in accordance with the second embodiment of the invention;

FIG. 15 depicts a longitudinal aberration diagram of the optical system in accordance with the second embodiment of the invention;

FIG. 16 is a field curvature and a distortion diagrams of the optical system in accordance with the second embodiment of the invention;

FIG. 17 is a lateral color diagram of the optical system in accordance with the second embodiment of the invention; and

FIG. 18 is a modulation transfer function diagram of the optical system in accordance with the second embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides an optical system including an optical module. The optical module is with positive refractive power and includes a first lens, a second lens, and a third lens. The first lens is with positive or negative refractive power and includes a convex surface facing an object side, and a convex surface, a concave surface, or a plane surface facing an image side. The first lens is not a biconvex lens when the refractive power of the first lens is negative and the first lens is not a biconcave lens when the refractive power of the first lens is positive. The second lens has a refractive power opposite to that of the first lens, and the surface shape can be biconvex, biconcave, meniscus, plano-convex, or plano-concave, and any surfaces can face the object side or the image side. The second lens is not a biconvex lens when the refractive power of the second lens is negative and the second lens is not a biconcave lens when the refractive power of the second lens is positive. The third lens is a biconcave lens with negative refractive power and includes a concave surface facing the object side and another concave surface facing the image side. The first lens, the second lens, and the third lens are arranged in order from the object side to the image side along an optical axis. The basic function of the optical system of the present invention can be achieved when the optical system of the present invention satisfies the above features, and does not require other additional features or conditions.

The present invention provides another optical system, based on the foregoing, the optical system further satisfies the condition: 5×10⁻⁶≤fLG1/fLGM≤2×10⁻⁴; wherein fLG1 is a combined effective focal length of the first lens and the second lens and fLGM is an effective focal length of the optical module, thereby achieving the basic function of the optical system of the present invention.

The present invention provides yet another optical system, based on the foregoing, the optical system further satisfies the condition: −1.6≤(R11LG2+R12LG2)/R11LG1≤4.7; wherein R11LG2 is a radius of curvature of an object side surface of the third lens, R12LG2 is a radius of curvature of an image side surface of the third lens, R11LG1 is a radius of curvature of an object side surface of the first lens, thereby achieving the basic function of the optical system of the present invention.

The present invention provides another optical system, based on the foregoing, the optical system further satisfies the condition: 39000≤fLGM/dLG1LG2≤83000; wherein fLGM is an effective focal length of the optical module and dLG1LG2 is an interval from an object side surface of the first lens to an image side surface of the third lens along the optical axis, thereby achieving the basic function of the optical system of the present invention.

The present invention provides yet another optical system, based on the foregoing, the optical system further satisfies the condition: 0.8≤DLG1/DLG2≤1.2; wherein DLG1 is an effective optical diameter of the first lens and DLG2 is an effective optical diameter of the third lens, thereby achieving the basic function of the optical system of the present invention.

The present invention provides another optical system, based on the foregoing, the optical system satisfies the condition: 0.3 mm⁻¹≤R12LG2/R11LG1/MLGM≤4.2 mm⁻¹; wherein R12LG2 is a radius of curvature of an image side surface of the third lens, R11LG1 is a radius of curvature of an object side surface of the first lens, and MLGM is a variable magnification of the optical module, thereby achieving the basic function of the optical system of the present invention.

The present invention provides yet another optical system including an optical module. The optical module is with positive refractive power and consists of three or four lenses. The optical module includes a first lens, a second lens, and a third lens, and there is no air gap between the first lens and the second lens. The first lens is with positive or negative refractive power and includes a convex surface facing an object side, and a convex surface, a concave surface, or a plane surface facing an image side. The first lens is not a biconvex lens when the refractive power of the first lens is negative and the first lens is not a biconcave lens when the refractive power of the first lens is positive. The second lens has a refractive power opposite to that of the first lens, and the surface shape can be biconvex, biconcave, meniscus, plano-convex, or plano-concave, and any surfaces can face the object side or the image side. The second lens is not a biconvex lens when the refractive power of the second lens is negative and the second lens is not a biconcave lens when the refractive power of the second lens is positive. The third lens is a biconcave lens with negative refractive power and includes a concave surface facing the object side and another concave surface facing the image side. The first lens, the second lens, and the third lens are arranged in order from the object side to the image side along an optical axis. The basic function of the optical system of the present invention can be achieved when the optical system of the present invention satisfies the above features, and does not require other additional features or conditions.

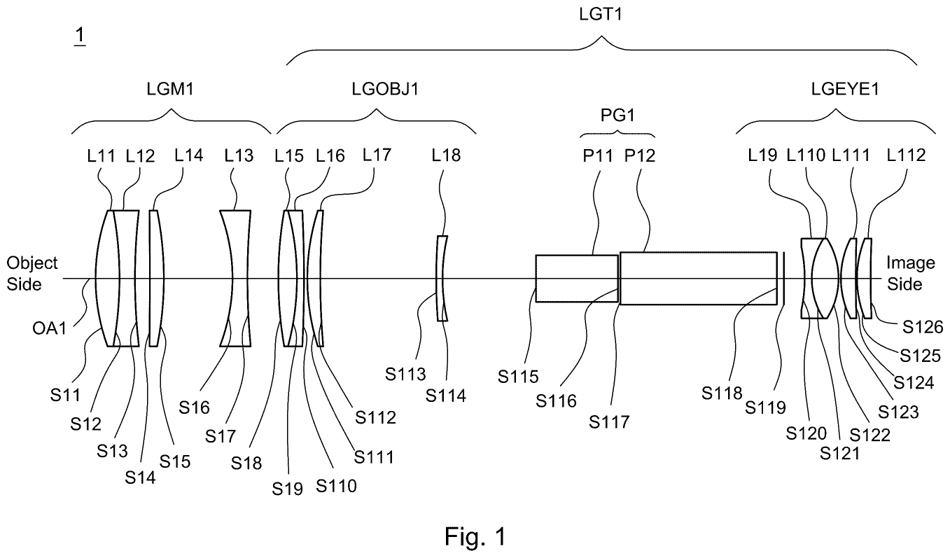

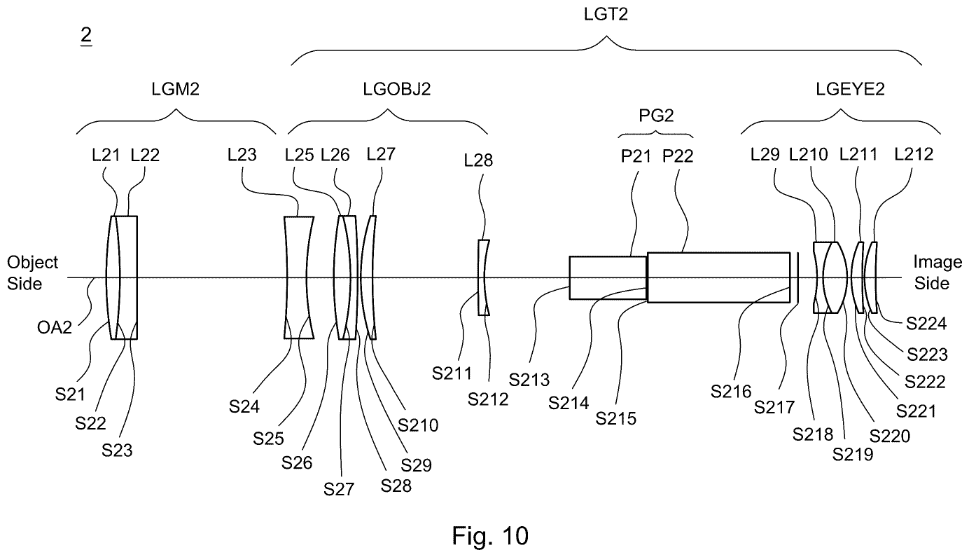

The present invention provides another optical system. Please refer to Table 1 and Table 3, wherein Table 1 and Table 3 show optical specification in accordance with a first and second embodiments of the invention, respectively. FIG. 1 and FIG. 10 are lens layout diagrams of the optical system in accordance with the first and second embodiments of the invention, respectively. All lenses in the first and second embodiments may be, but are not limited to, spherical surface and made of glass material.

The optical systems 1, 2 include optical modules LGM1, LGM2 and telephoto optical modules LGT1, LGT2, respectively. The optical modules LGM1, LGM2 include the first lenses L11, L21, the second lenses L12, L22, and the third lenses L13, L23, respectively. The first lenses L11, L21 are biconvex lenses with positive refractive power, wherein the object side surfaces S11, S21 are convex surfaces and the image side surfaces S12, S22 are convex surfaces. The second lenses L12, L22 are with negative refractive power, wherein the object side surfaces S12, S22 are concave surfaces. The first lenses L11, L21 and the second lenses L12, L22 are cemented, respectively, or there is no air gap between the first lenses L11, L21 and the second lenses L12, L22, respectively. The combination of the first lenses L11, L21 and the second lenses L12, L22 has positive refractive power, respectively. The third lenses L13, L23 are biconcave lenses with negative refractive power, wherein the object side surfaces S16, S24 are concave surfaces and the image side surfaces S17, S25 are concave surfaces.

The telephoto optical modules LGT1, LGT2 include objective lens modules LGOBJ1, LGOBJ2, prism modules PG1, PG2, and the eyepiece modules LGEYE1, LGEYE2, respectively. The objective lens modules LGOBJ1, LGOBJ2 include the fifth lenses L15, L25, the sixth lenses L16, L26, the seventh lenses L17, L27, and the eighth lenses L18, L28, respectively. The fifth lenses L15, L25 are biconvex lenses with positive refractive power, wherein the object side surfaces S18, S26 are convex surfaces and the image side surfaces S19, S27 are convex surfaces. The sixth lenses L16, L26 are meniscus lenses with negative refractive power, wherein the object side surfaces S19, S27 are concave surfaces and the image side surfaces S110, S28 are convex surfaces. The fifth lenses L15, L25 and the sixth lenses L16, L26 are cemented, respectively, or there is no air gap between the fifth lenses L15, L25 and the sixth lenses L16, L26, respectively. The combination of the fifth lenses L15, L25 and the sixth lenses L16, L26 has positive refractive power, respectively. The seventh lenses L17, L27 are meniscus lenses with positive refractive power, wherein the object side surfaces S111, S29 are convex surfaces and the image side surfaces S112, S210 are concave surfaces. The eighth lenses L18, L28 are meniscus lenses with negative refractive power, wherein the object side surfaces S113, S211 are convex surfaces and the image side surfaces S114, S212 are concave surfaces.

The prism modules include the first prism P11, P21 and the second prism P12, P22, respectively. The first prisms P11, P21 are made of glass material, wherein the object side surfaces S115, S213 are plane surfaces and the image side surfaces S116, S214 are plane surfaces. The second prisms P12, P22 are made of glass material, wherein the object side surfaces S117, S215 are plane surfaces and the image side surfaces S118, S216 are plane surfaces.

The eyepiece modules LGEYE1, LGEYE2 include the ninth lenses L19, L29, the tenth lenses L110, L210, the eleventh lenses L111, L211, and the twelfth lenses L112, L212, respectively. The ninth lenses L19, L29 are biconcave lenses with negative refractive power, wherein the object side surfaces S120, S218 are concave surfaces and the image side surfaces S121, S219 are concave surfaces. The tenth lenses L110, L210 are biconvex lenses with positive refractive power, wherein the object side surfaces S121, S219 are convex surfaces and the image side surfaces S122, S220 are convex surfaces. The ninth lenses L19, L29 and the tenth lenses L110, L210 are cemented, respectively, or there is no air gap between the ninth lenses L19, L29 and the tenth lenses L110, L210, respectively. The combination of the ninth lenses L19, L29 and the tenth lenses L110, L210 has positive refractive power, respectively. The eleventh lenses L111, L211 are meniscus lenses with positive refractive power, wherein the object side surfaces S123, S221 are convex surfaces and the image side surfaces S124, S222 are concave surfaces. The twelfth lenses L112, L212 are meniscus lenses with positive refractive power, wherein the object side surfaces S125, S223 are convex surfaces and the image side surfaces S126, S224 are concave surfaces.

In addition, the optical systems 1, 2 satisfy at least one of the following conditions:

$$5 \times 1 {0}^{- 6} \leq fLG 1 / fLGM \leq 2 \times 1 {0}^{- 4} ; \qquad ( 1 )$$

$$- 1.6 \leq ( R 11 LG 2 + R 12 LG 2 ) / R 11 LG 1 \leq 4.7 ; \qquad ( 2 )$$

$$39000 \leq fLGM / dLG 1 LG 2 \leq 83000 ; \qquad ( 3 )$$

$$0.8 \leq DLG 1 / DLG 2 \leq 1.2 ; \qquad ( 4 )$$

$$0.3 {mm}^{- 1} \leq ( R 12 LG 2 / R 11 LG 1 ) / MLGM \leq 4.2 {mm}^{- 1} ; \qquad ( 5 )$$

wherein fLG1 is a combined effective focal length of the first lenses L11, L21 and the second lenses L12, L22 for the first to second embodiments, fLGM is an effective focal length of the optical modules LGM1, LGM2 for the first to second embodiments, R11LG2 is a radius of curvature of the object side surfaces S16, S24 of the third lenses L13, L23 for the first to second embodiments, R12LG2 is a radius of curvature of the image side surfaces S17, S25 of the third lenses L13, L23 for the first to second embodiments, R11LG1 is a radius of curvature of the object side surfaces S11, S21 of the first lenses L11, L21 for the first to second embodiments, dLG1LG2 is an interval from the object side surfaces S11, S21 of the first lenses L11, L21 to the image side surfaces S17, S25 of the third lenses L13, L23 along the optical axes OA1, OA2 for the first to second embodiments, DLG1 is an effective optical diameter of the first lenses L11, L21 for the first to second embodiments, DLG2 is an effective optical diameter of the third lenses L13, L23 for the first to second embodiments, and MLGM is a variable magnification of the optical modules LGM1, LGM2 for the first to second embodiments. With the optical systems 1, 2 satisfying at least one of the above conditions (1)-(5), the variable magnification can be effectively increased and the aberration can be effectively corrected.

A detailed description of an optical system in accordance with a first embodiment of the invention is as follows. Referring to FIG. 1, the optical system 1 includes an optical module LGM1 and a telephoto optical module LGT1, all of which are arranged in order from an object side to an image side along an optical axis OA1. The optical module LGM1 includes a first lens L11, a second lens L12, a fourth lens L14, and a third lens L13, all of which are arranged in order from the object side to the image side along the optical axis OA1. The first lens L11 and the second lens L12 are cemented, or there is no air gap between the first lens L11 and the second lens L12. The first lens L11, the second lens L12, the fourth lens L14, and the third lens L13 are arranged in order from the object side to the image side along the optical axis OA1. The telephoto optical module LGT1 includes an objective lens module LGOBJ1, a prism module PG1, and an eyepiece module LGEYE1, all of which are arranged in order from the object side to the image side along the optical axis OA1. The objective lens module LGOBJ1 includes a fifth lens L15, a sixth lens L16, a seventh lens L17, and an eighth lens L18. The prism module PG1 includes a first prism P11 and a second prism P12. The eyepiece module LGEYE1 includes a ninth lens L19, a tenth lens L110, an eleventh lens L111, and a twelfth lens L112. The fifth lens L15, the sixth lens L16, the seventh lens L17, the eighth lens L18, the first prism P11, the second prism P12, the ninth lens L19, the tenth lens L110, the eleventh lens L111, and the twelfth lens L112 are arranged in order from the object side to the image side along the optical axis OA1. The variable magnification of the optical module LGM1 of the optical system 1 is 1.4 times for the first embodiment. In operation, a light from the object side first enters the optical module LGM1 and then the telephoto optical module LGT1. The light from the object side is first magnified 1.4 times and imaged on the first focal plane S119 then passes through the ninth lens L19, the tenth lens L110, the eleventh lens L111 and the twelfth lens L112 in sequence, and is finally viewed by the human eyes.

According to the foregoing, wherein: the second lens L12 is a biconcave lens, wherein the image side surface S13 is a concave surface and the image side surface S13 is a spherical surface; the fourth lens L14 is a meniscus lens with positive refractive power and made of glass material, wherein the object side surface S14 is a concave surface, the image side surface S15 is a convex surface, and both of the object side surface S14 and image side surface S15 are spherical surfaces. With the above design of the lenses and at least one of the conditions (1)-(5) satisfied, the optical system 1 can have an effective increased variable magnification and an effective corrected aberration.

Table 1 shows the optical specification of the optical system 1 in FIG. 1.

TABLE 1

| | | | | | Effective | Effective | |
|---|---|---|---|---|---|---|---|
| | Radius of | | | | Focal | Optical | |
| Surface | Curvature | Thickness | | | Length | Diameter | |
| Number | (mm) | (mm) | Nd | Vd | (mm) | (mm) | Remark |
| S11 | 62.94 | 7.38 | 1.5691 | 71.304 | 70.93 | 44 | L11 |
| S12 | −107.73 | 5.1 | 1.8467 | 23.784 | −76.05 | 44 | L12 |
| S13 | 163.54 | 5.17 | | | | 44 | |
| S14 | −990.7 | 4.61 | 1.9591 | 17.472 | 117.15 | 44 | L14 |
| S15 | −101.14 | 22.47 | | | | 44 | |
| S16 | −57.41 | 5.01 | 1.6516 | 58.394 | −73.62 | 44 | L13 |
| S17 | 301.71 | 10 | | | | 44 | |
| S18 | 124.67 | 6 | 1.6385 | 55.429 | 81.26 | 44 | L15 |
| S19 | −87.20 | 2.4 | 1.7283 | 28.319 | −148.98 | 44 | L16 |
| S110 | −449.33 | 0.9 | | | | 44 | |
| S111 | 66.54 | 4.2 | 1.4875 | 70.393 | 208.76 | 44 | L17 |
| S112 | 188.25 | 38.3 | | | | 44 | |
| S113 | 276.17 | 1.8 | 1.5264 | 60.157 | −125.97 | 27 | L18 |
| S114 | 53.35 | 30.7 | | | | 27 | |
| S115 | ∞ | 27.14 | 1.5688 | 56.041 | | 15.08 | P11 |
| S116 | ∞ | 0.8 | | | | 13.4 | |
| S117 | ∞ | 51 | 1.5688 | 56.041 | | 13.4 | P12 |
| S118 | ∞ | 2.46 | | | | 16.73 | |
| S119 | ∞ | 6.89 | | | | 17.23 | |
| S120 | −45.33 | 1.84 | 1.946 | 17.942 | −15.38 | 19.34 | L19 |
| S121 | 21.86 | 9.27 | 1.7292 | 54.642 | 16.46 | 25.4 | L110 |
| S122 | −21.86 | 0.95 | | | | 25.4 | |
| S123 | 28.9 | 4.42 | 1.7725 | 49.599 | 41.99 | 25.4 | L111 |
| S124 | 247.37 | 0.25 | | | | 25.4 | |
| S125 | 28.9 | 4.42 | 1.7725 | 49.599 | 41.99 | 25.4 | L112 |
| S126 | 247.37 | 16.29 | | | | 25.4 | |

Table 2 shows the parameters and condition values for conditions (1)-(5) in accordance with the optical system 1 of the first embodiment. It can be seen from Table 2 that the optical system 1 of the first embodiment satisfies the conditions (1)-(5).

TABLE 2

| | | | | | |
|---|---|---|---|---|---|
| fLG1 | 584.47 | mm | fLGM | 3.5 × 10⁶ | mm |
| R11LG2 | −57.41 | mm | R12LG2 | 301.71 | mm |
| R11LG1 | 62.94 | mm | dLG1G2 | 49.74 | mm |
| DLG1 | 44 | mm | DLG2 | 44 | mm |

| MLGM | 1.4 | | | |
|---|---|---|---|---|
| fLG1/fLGM | 1.67 × 10⁻⁴ | | (R11LG2 + | 3.88 |
| | | | R12LG2)/ | |
| | | | R11LG1 | |
| fLGM/dLG1LG2 | 70365.9 | | DLG1/DLG2 | 1 |
| R12LG2/ | 3.42 | mm⁻¹ | | |
| R11LG1/MLGM | | | | |

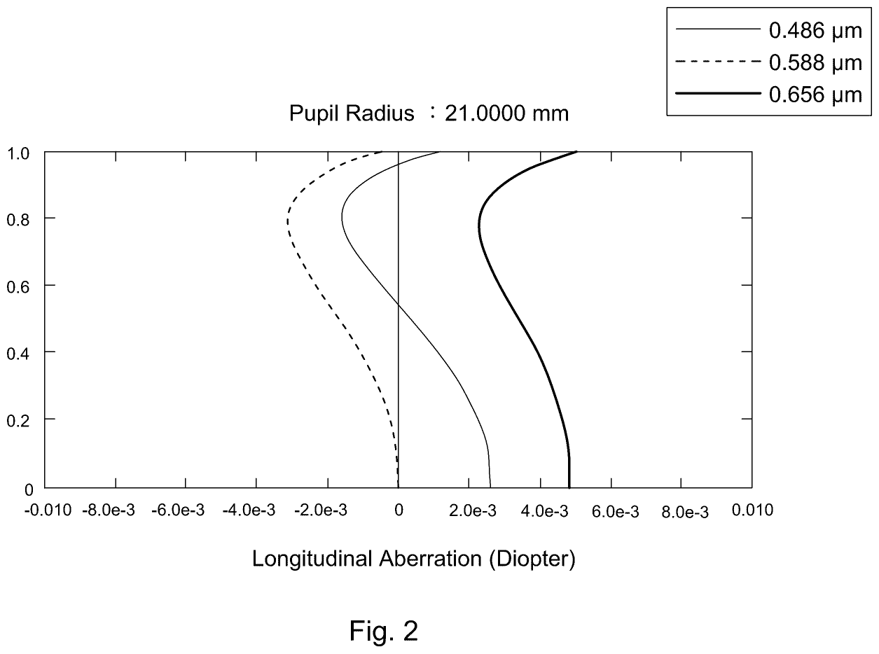

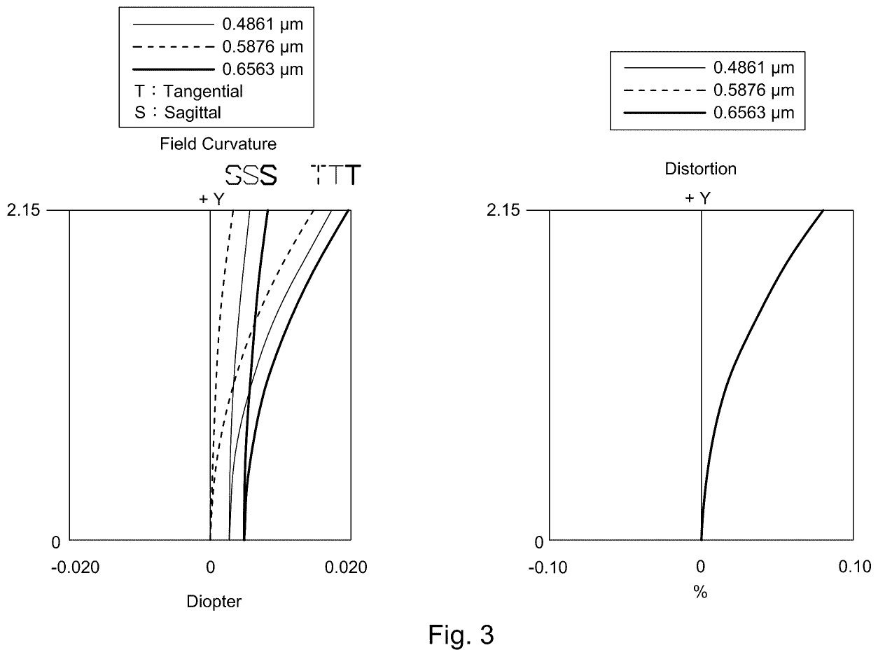

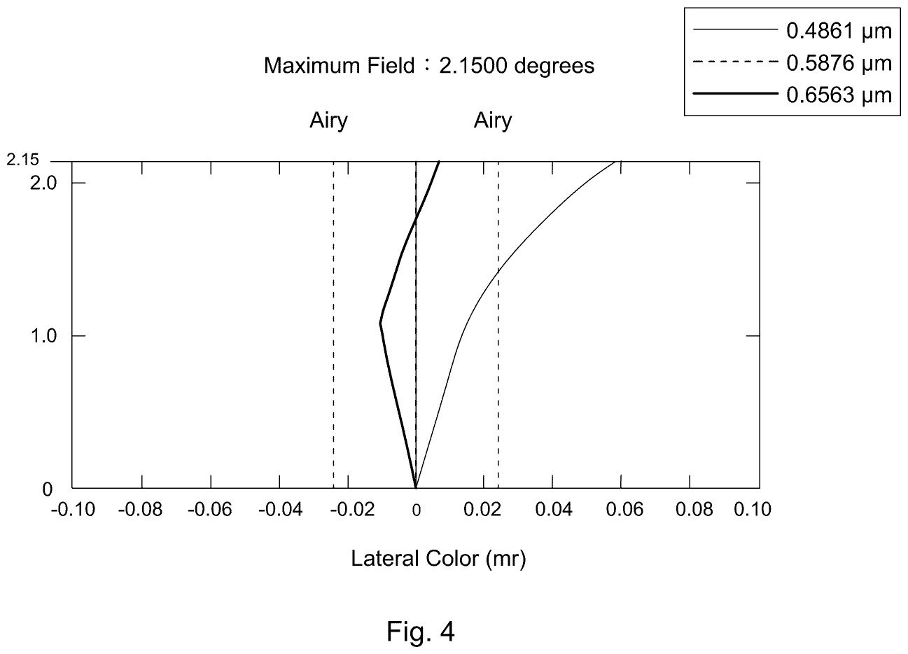

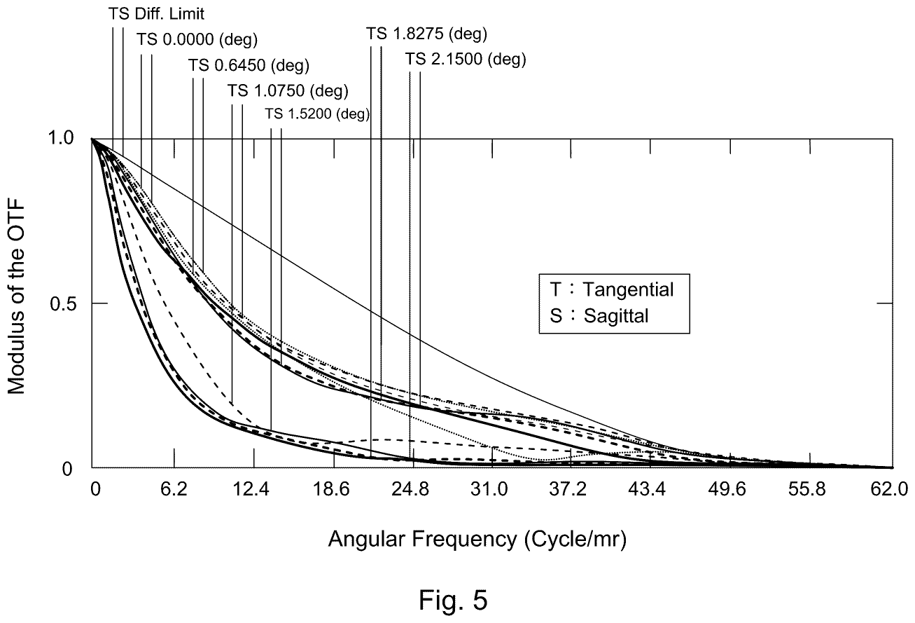

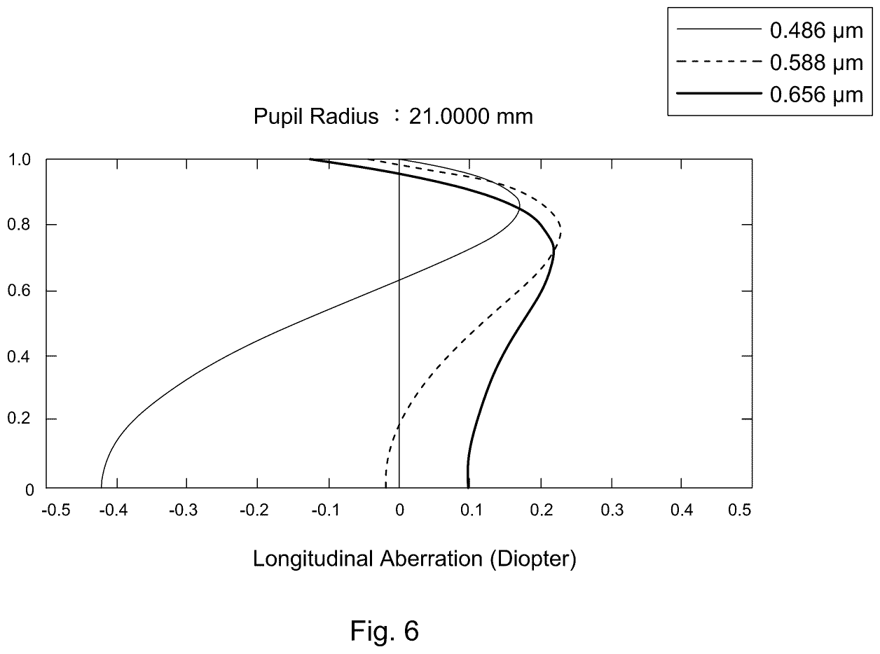

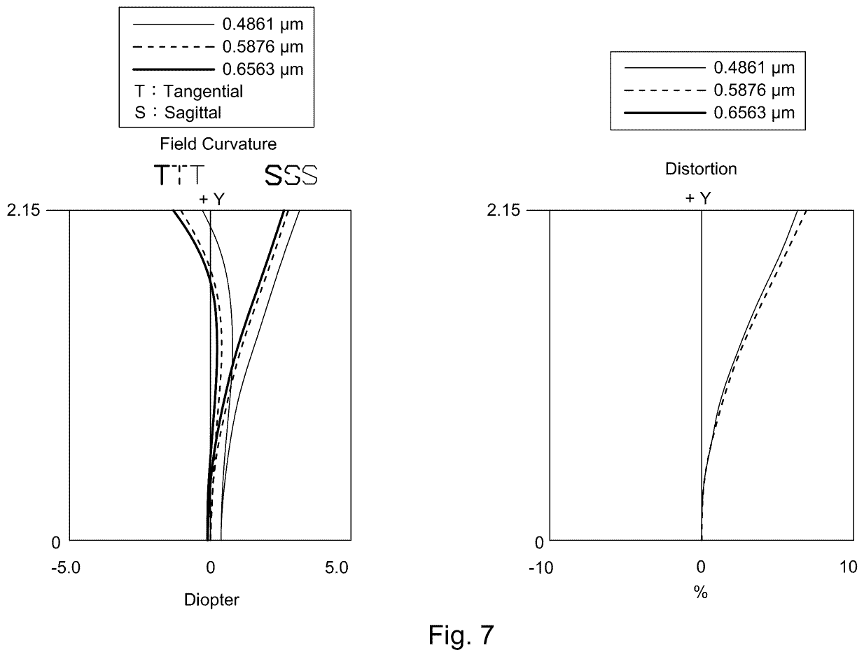

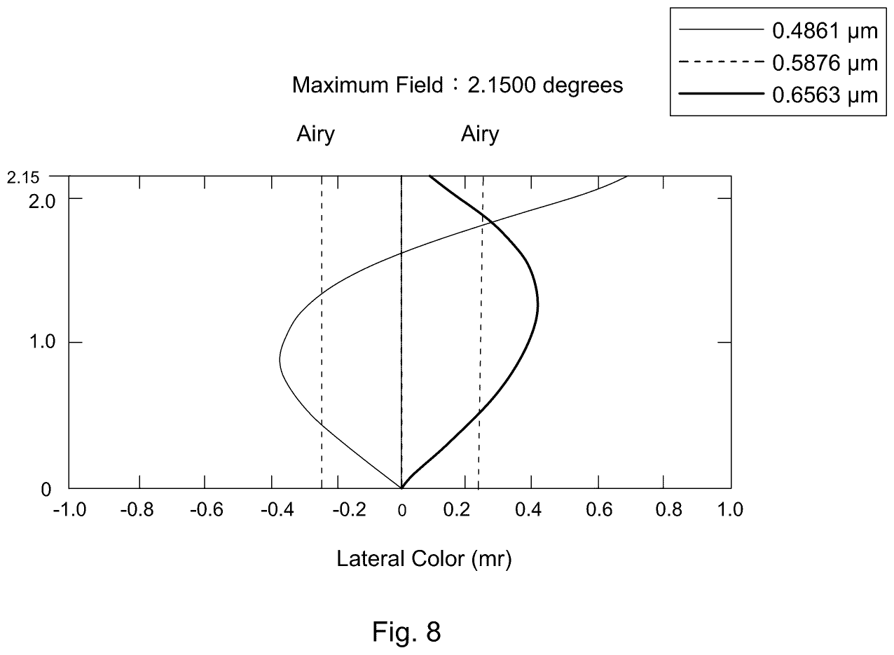

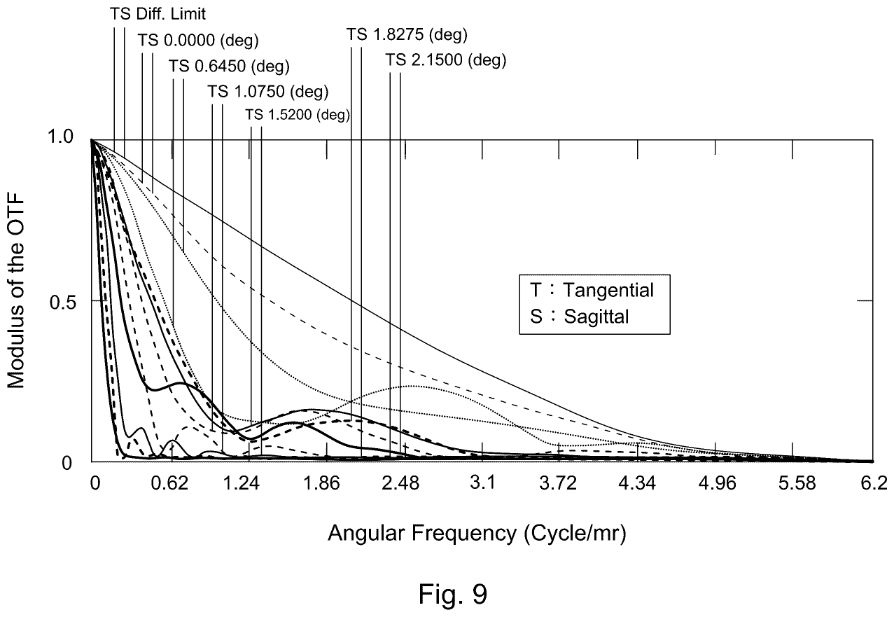

In addition, the optical system 1 of the first embodiment can meet the requirements of optical performance as seen in FIGS. 2-8. It can be seen from FIG. 2 that the longitudinal aberration in the optical module LGM1 of the optical system 1 of the first embodiment ranges from −4×10⁻³ diopters to 6×10⁻³ diopters. It can be seen from FIG. 3 that the field curvature of tangential direction and sagittal direction and distortion in the optical module LGM1 of the optical system 1 of the first embodiment ranges from 0 diopters to 0.02 diopters and 0% to 0.08%, respectively. It can be seen from FIG. 4 that the lateral color in the optical module LGM1 of the optical system 1 of the first embodiment ranges from −0.02 mr to 0.06 mr. It can be seen from FIG. 5 that the modulation transfer function of tangential direction and sagittal direction in the optical module LGM1 of the optical system 1 of the first embodiment ranges from 0.0 to 1.0. It can be seen from FIG. 6 that the longitudinal aberration in the optical system 1 of the first embodiment ranges from −0.45 diopters to 0.25 diopters. It can be seen from FIG. 7 that the field curvature of tangential direction and sagittal direction and distortion in the optical system 1 of the first embodiment ranges from −1.5 diopters to 3.5 diopters and 0% to 8%, respectively. It can be seen from FIG. 8 that the lateral color in the optical system 1 of the first embodiment ranges from −0.4 mr to 0.7 mr. It can be seen from FIG. 9 that the modulation transfer function of tangential direction and sagittal direction in the optical system 1 of the first embodiment ranges from 0.0 to 1.0. It is obvious that the longitudinal aberration, the field curvature, the distortion, and the lateral color of the optical system 1 and optical module LGM1 of the first embodiment can be corrected effectively and the image resolution can meet the requirements. Therefore, the optical system 1 and the optical module LGM1 of the first embodiment are capable of good optical performance.

A detailed description of an optical system in accordance with a second embodiment of the invention is as follows. Referring to FIG. 10, the optical system 2 includes an optical module LGM2 and a telephoto optical module LGT2, all of which are arranged in order from an object side to an image side along an optical axis OA2. The optical module LGM2 includes a first lens L21, a second lens L22, and a third lens L23, all of which are arranged in order from the object side to the image side along the optical axis OA2. The first lens L21 and the second lens L22 are cemented, or there is no air gap between the first lens L21 and the second lens L22. The first lens L21, the second lens L22, and the third lens L23 are arranged in order from the object side to the image side along the optical axis OA2. The telephoto optical module LGT2 includes an objective lens module LGOBJ2, a prism module PG2, and an eyepiece module LGEYE2, all of which are arranged in order from the object side to the image side along the optical axis OA2. The objective lens module LGOBJ2 includes a fifth lens L25, a sixth lens L26, a seventh lens L27, and an eighth lens L28. The prism module PG2 includes a first prism P21 and a second prism P22. The eyepiece module LGEYE2 includes a ninth lens L29, a tenth lens L210, an eleventh lens L211, and a twelfth lens L212. The fifth lens L25, the sixth lens L26, the seventh lens L27, the eighth lens L28, the first prism P21, the second prism P22, the ninth lens L29, the tenth lens L210, the eleventh lens L211, and the twelfth lens L212 are arranged in order from the object side to the image side along the optical axis OA2. The variable magnification of the optical module LGM2 of the optical system 2 is 1.4 times for the second embodiment. In operation, a light from the object side first enters the optical module LGM2 and then the telephoto optical module LGT2. The light from the object side is first magnified 1.4 times and imaged on the first focal plane S217 then passes through the ninth lens L29, the tenth lens L210, the eleventh lens L211 and the twelfth lens L212 in sequence, and is finally viewed by the human eyes.

According to the foregoing, wherein: the second lens L22 is a plano-concave lens, wherein the image side surface S23 is a plane surface. With the above design of the lenses and at least one of the conditions (1)-(5) satisfied, the optical system 2 can have an effective increased variable magnification and an effective corrected aberration.

Table 3 shows the optical specification of the optical system 2 in FIG. 10.

TABLE 3

| | | | | | Effective | Effective | |
|---|---|---|---|---|---|---|---|
| | Radius of | | | | Focal | Optical | |
| Surface | Curvature | Thickness | | | Length | Diameter | |
| Number | (mm) | (mm) | Nd | Vd | (mm) | (mm) | Remark |
| S21 | 138.93 | 5.00 | 1.603 | 65.46 | 115.98 | 44 | L21 |
| S22 | −138.93 | 6.03 | 1.575 | 41.505 | −241.61 | 44 | L22 |
| S23 | ∞ | 53.45 | | | | 44 | |
| S24 | −278.43 | 7.00 | 1.4378 | 94.523 | −156.40 | 44 | L23 |
| S25 | 91.49 | 10 | | | | 44 | |
| S26 | 124.67 | 6 | 1.6385 | 55.429 | 81.26 | 44 | L25 |
| S27 | −87.20 | 2.4 | 1.7283 | 28.319 | −148.98 | 44 | L26 |
| S28 | −449.33 | 0.9 | | | | 44 | |
| S29 | 66.54 | 4.2 | 1.4875 | 70.393 | 208.76 | 44 | L27 |
| S210 | 188.25 | 38.3 | | | | 44 | |
| S211 | 276.17 | 1.8 | 1.5264 | 60.157 | −125.97 | 27 | L28 |
| S212 | 53.35 | 30.7 | | | | 27 | |
| S213 | ∞ | 27.14 | 1.5688 | 56.041 | | 15.08 | P21 |
| S214 | ∞ | 0.8 | | | | 13.4 | |
| S115 | ∞ | 51 | 1.5688 | 56.041 | | 13.4 | P22 |
| S116 | ∞ | 2.46 | | | | 16.73 | |
| S117 | ∞ | 6.89 | | | | 17.23 | |
| S118 | −45.33 | 1.84 | 1.946 | 17.942 | −15.38 | 19.34 | L29 |
| S119 | 21.86 | 9.27 | 1.7292 | 54.642 | 16.46 | 25.4 | L210 |
| S120 | −21.86 | 0.95 | | | | 25.4 | |
| S121 | 28.9 | 4.42 | 1.7725 | 49.599 | 41.99 | 25.4 | L211 |
| S122 | 247.37 | 0.25 | | | | 25.4 | |
| S123 | 28.9 | 4.42 | 1.7725 | 49.599 | 41.99 | 25.4 | L212 |
| S124 | 247.37 | 16.29 | | | | 25.4 | |

Table 4 shows the parameters and condition values for conditions (1)-(5) in accordance with the optical system 2 of the second embodiment. It can be seen from Table 4 that the optical system 2 of the second embodiment satisfies the conditions (1)-(5).

TABLE 4

| | | | | | |
|---|---|---|---|---|---|
| fLG1 | 220.31 | mm | fLGM | 3.5 × 10⁷ | mm |
| R11LG2 | −278.43 | mm | R12LG2 | 91.49 | mm |
| R11LG1 | 138.93 | mm | dLG1G2 | 71.48 | mm |
| DLG1 | 44 | mm | DLG2 | 44 | mm |

| MLGM | 1.4 | | | |
|---|---|---|---|---|
| fLG1/fLGM | 6.29 × 10⁻⁶ | | (R11LG2 + | −1.35 |
| | | | R12LG2)/ | |
| | | | R11LG1 | |
| fLGM/dLG1LG2 | 489647.5 | | DLG1/DLG2 | 1 |
| R12LG2/ | 0.47 | mm⁻¹ | | |
| R11LG1/MLGM | | | | |

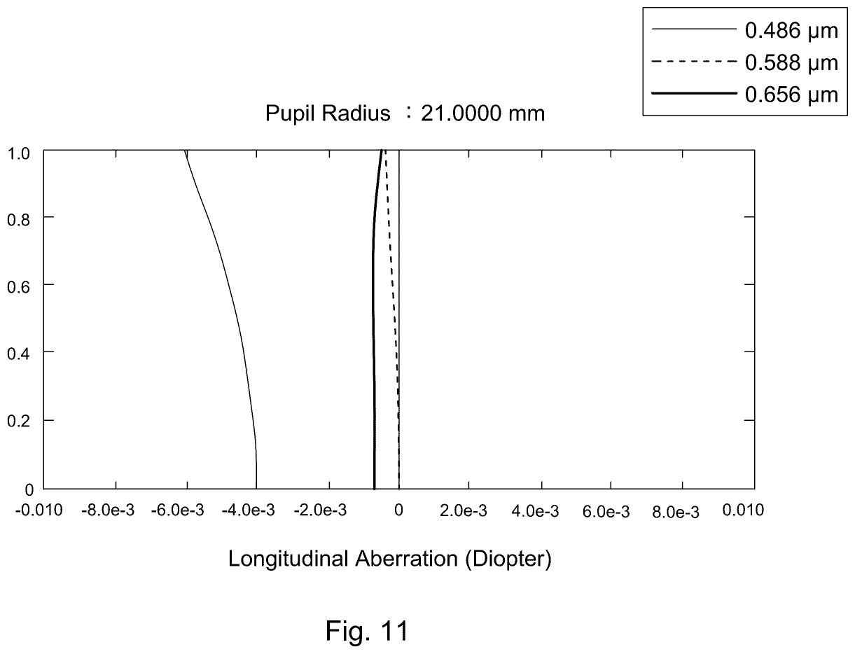

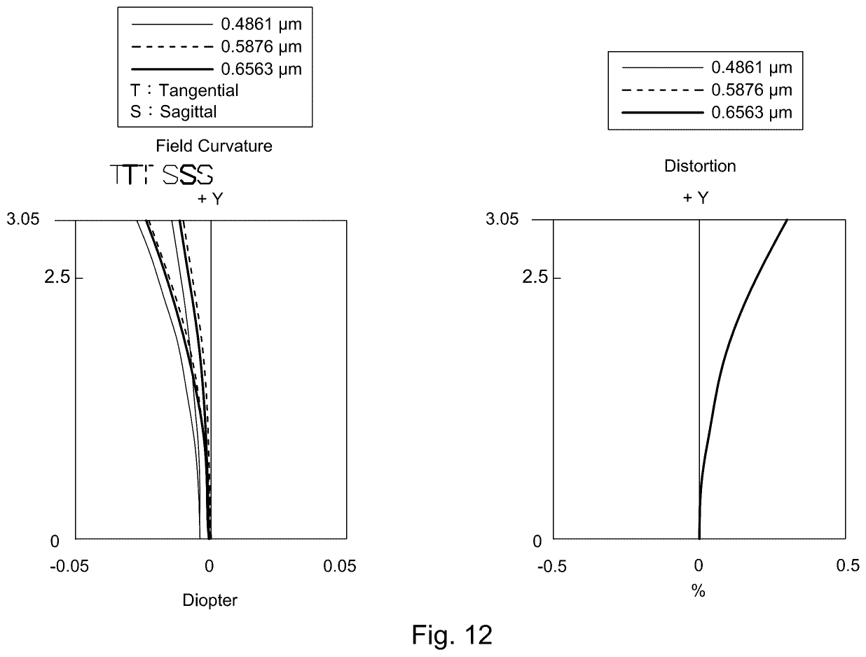

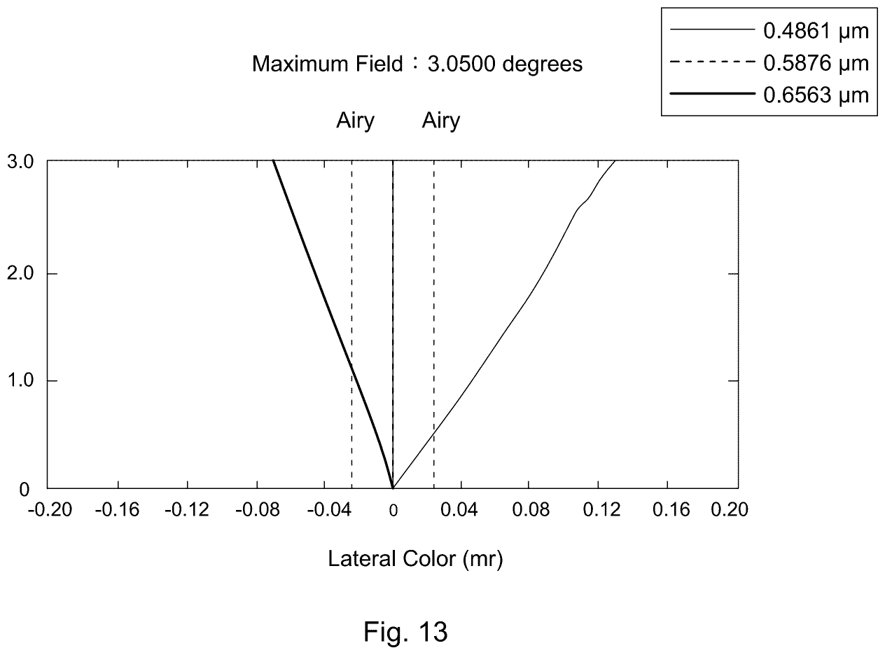

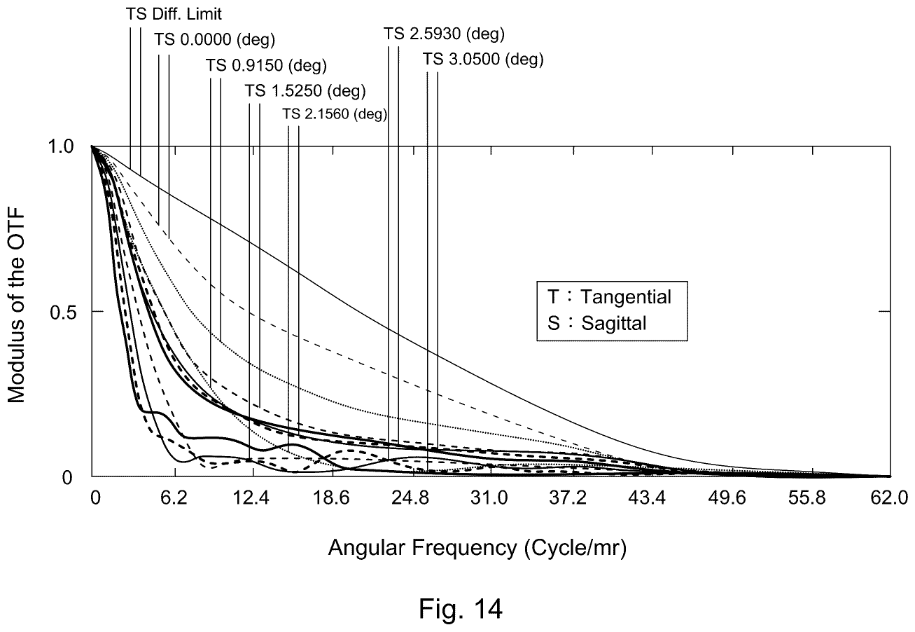

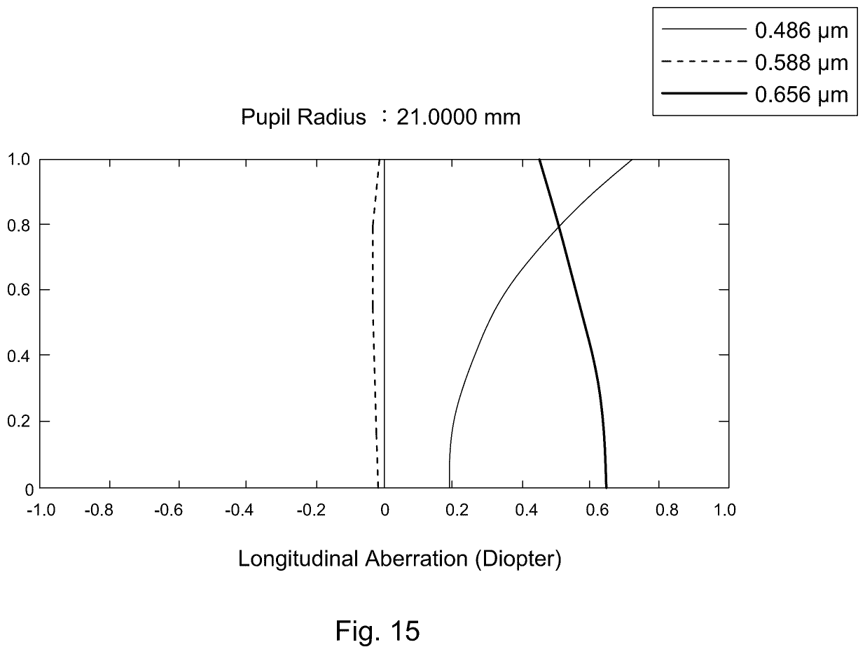

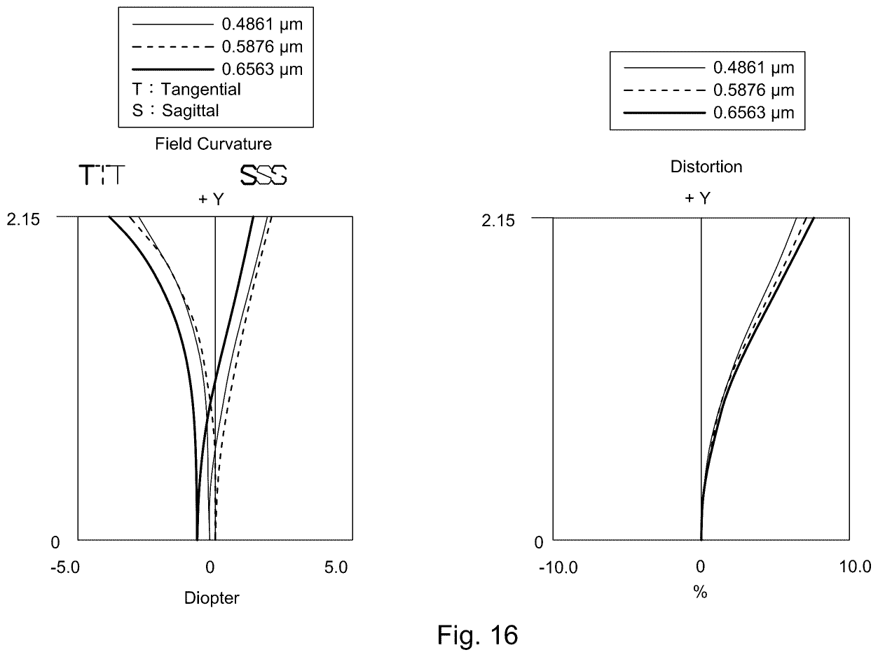

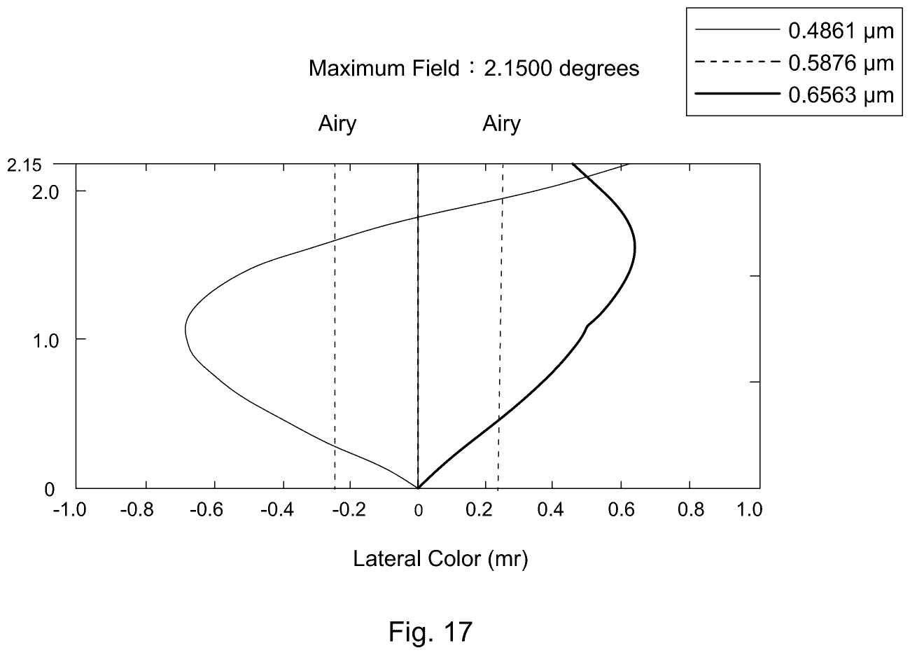

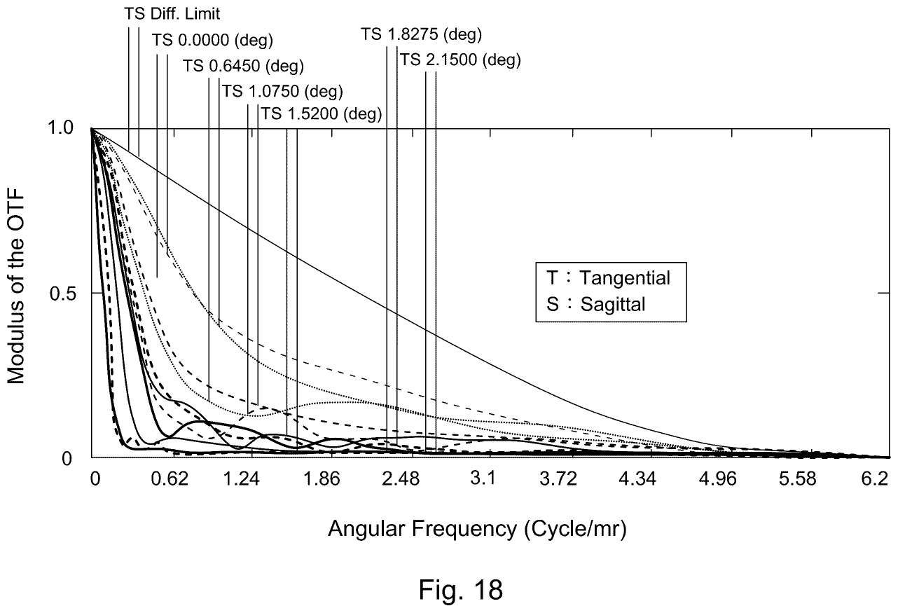

In addition, the optical system 2 of the second embodiment can meet the requirements of optical performance as seen in FIGS. 11-18. It can be seen from FIG. 11 that the longitudinal aberration in the optical module LGM2 of the optical system 2 of the second embodiment ranges from −6×10⁻³ diopters to 0.0 diopters. It can be seen from FIG. 12 that the field curvature of tangential direction and sagittal direction and distortion in the optical module LGM2 of the optical system 2 of the second embodiment ranges from −0.03 diopters to 0.0 diopters and 0% to 0.3%, respectively. It can be seen from FIG. 13 that the lateral color in the optical module LGM2 of the optical system 2 of the second embodiment ranges from −0.08 mr to 0.14 mr. It can be seen from FIG. 14 that the modulation transfer function of tangential direction and sagittal direction in the optical module LGM2 of the optical system 2 of the second embodiment ranges from 0.0 to 1.0. It can be seen from FIG. 15 that the longitudinal aberration in the optical system 2 of the second embodiment ranges from −0.1 diopters to 0.7 diopters. It can be seen from FIG. 16 that the field curvature of tangential direction and sagittal direction and distortion in the optical system 2 of the second embodiment ranges from −4.0 diopters to 2.0 diopters and 0% to 8%, respectively. It can be seen from FIG. 17 that the lateral color in the optical system 2 of the second embodiment ranges from −0.7 mr to 0.7 mr. It can be seen from FIG. 18 that the modulation transfer function of tangential direction and sagittal direction in the optical system 2 of the second embodiment ranges from 0.0 to 1.0. It is obvious that the longitudinal aberration, the field curvature, the distortion, and the lateral color of the optical system 2 and optical module LGM2 of the second embodiment can be corrected effectively and the image resolution can meet the requirements. Therefore, the optical system 2 and the optical module LGM2 of the second embodiment are capable of good optical performance.

The third embodiment of the optical system of the present invention is described below. The third embodiment differs from the first embodiment or the second embodiment only in that the lenses are made of plastic material and aspheric lenses.

The fourth embodiment of the optical system of the present invention is described below. The fourth embodiment differs from the first embodiment or the second embodiment only in that an air gap is provided between the first lens and the second lens.

The fifth embodiment of the optical system of the present invention is described below. The fifth embodiment of the optical system is composed of the optical module of the optical system of the first embodiment or the second embodiment in combination with other telephoto optical module. The other telephoto optical module includes an eyepiece module and an objective lens module. One end of the objective lens module is connected to the optical module, and the other end of the objective lens module is connected to the eyepiece module. The effective focal length of the objective lens module is greater than the effective focal length of the eyepiece module, and the effective optical diameter of the objective lens module is greater than the effective optical diameter of the eyepiece module, so that the other telephoto optical module increase its variable magnification.

The sixth embodiment of the optical system of the present invention is described below. The sixth embodiment differs from the fifth embodiment only is that the effective optical diameter of the optical module is not limited to 44 mm, instead, it can be 40 mm or more.

A seventh embodiment of the optical system of the present invention is described below. The seventh embodiment differs from the fifth embodiment only is that the seventh embodiment further satisfies the following conditions: 0 mm<dLG2L5≤30 mm; 6≤fLGOBJ/fLGEYE≤10; wherein dLG2L5 is an interval from 480 the image side surface of the third lens to the lens of the objective lens module closest to the object side along the optical axis, fLGOBJ is the effective focal length of the objective lens module, and fLGEYE is the effective focal length of the eyepiece module.

The above-mentioned prism module can rotate the direction of the image from the objective lens module. For example, if the image from the objective lens module is an inverted image, the image can be rotated into an upright image after passing through the prism module, so that the prism module can also be called an erect optical module.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical system comprising: an optical module;
wherein the optical module is with positive refractive power and comprises a first lens, a second lens, and a third lens;
wherein the first lens is with refractive power and comprises a convex surface facing an object side;
wherein the second lens is with refractive power;
wherein the third lens is a biconcave lens with negative refractive power and comprises a concave surface facing the object side and another concave surface facing an image side;
wherein the first lens, the second lens, and the third lens are arranged in order from the object side to the image side along an optical axis;
wherein the optical module satisfies at least one of following conditions:
$$5 \times 1 {0}^{- 6} \leq fLG 1 / fLGM \leq 2 \times 1 {0}^{- 4} ;$$
$$39000 \leq fLGM / dLG 1 LG 2 \leq 83000 ;$$
$$0.8 \leq DLG 1 / DLG 2 \leq 1.2 ;$$
$$0.3 {mm}^{- 1} \leq ( R 12 LG 2 / R 11 LG 1 ) / MLGM \leq 4.2 {mm}^{- 1} ;$$
wherein fLG1 is a combined effective focal length of the first lens and the second lens, fLGM is an effective focal length of the optical module, R12LG2 is a radius of curvature of an image side surface of the third lens, R11LG1 is a radius of curvature of an object side surface of the first lens, dLG1LG2 is an interval from the object side surface of the first lens to the image side surface of the third lens along the optical axis, DLG1 is an effective optical diameter of the first lens, DLG2 is an effective optical diameter of the third lens, and MLGM is a variable magnification of the optical module.

2. The optical system as claimed in claim 1, wherein there is no air gap between the first lens and the second lens, and the optical system satisfies condition:
−1.6≤(R11LG2+R12LG2)/R11LG1≤4.7;
wherein R11LG2 is a radius of curvature of an object side surface of the third lens, R12LG2 is the radius of curvature of the image side surface of the third lens, and R11LG1 is the radius of curvature of the object side surface of the first les.

3. The optical system as claimed in claim 1, wherein the number of the lenses is four or less.

4. The optical system as claimed in claim 1, wherein:
the first lens is a biconvex lens with positive refractive power and further comprises another convex surface facing the image side; and
the second lens is with negative refractive power and comprises a concave surface facing the object side.

5. The optical system as claimed in claim 4, further comprising a fourth lens disposed between the second lens and the third lens, wherein the fourth lens is a meniscus lens with positive refractive power and comprises a concave surface facing the object side and a convex surface facing the image side.

6. The optical system as claimed in claim 5, wherein the second lens comprises a plane surface facing the image side.

7. The optical system as claimed in claim 4, wherein the second lens is a biconcave lens and comprises a concave surface facing the image side.

8. The optical system as claimed in claim 1, further comprising an objective lens module and an eyepiece module wherein:
the objective lens module is disposed between the optical module and the eyepiece module;
the eyepiece module is disposed between the objective lens module and the image side;
the optical module, the objective lens module, and the eyepiece module are arranged in order from the object side to the image side along the optical axis; and
the optical system satisfies at least one of following conditions:
$$0 mm < dLG 2 L 5 \leq 30 mm ;$$
$$6 \leq fL GOBJ / fLGEYE \leq 10 ;$$
wherein dLG2L5 is an interval from the image side surface of the third lens to a lens of the objective lens module closest to the object side along the optical axis, fLGOBJ is the effective focal length of the objective lens module, and fLGEYE is the effective focal length of the eyepiece module.

9. The optical system as claimed in claim 8, wherein:
an effective focal length of the objective lens module is greater than an effective focal length of the eyepiece module; and
an effective optical diameter of the objective lens module is greater than an effective optical diameter of the eyepiece module.

10. The optical system as claimed in claim 1, further comprising an objective lens module, a prism module, and an eyepiece module, all of which are arranged in order from the object side to the image side along the optical axis, wherein:
the objective lens module, the prism module, and the eyepiece module are disposed between the optical module and the image side;
the objective lens module consists of four lenses with refractive power;
the prism module comprises a first prism and a second prism; and
the eyepiece module consists of four lenses with refractive power.

11. The optical system as claimed in claim 1, further comprising an objective lens module, a prism module, and an eyepiece module, all of which are arranged in order from the object side to the image side along the optical axis, wherein:
the objective lens module, the prism module, and the eyepiece module are disposed between the optical module and the image side;
the objective lens module comprises a fifth lens, a sixth lens, a seventh lens, and an eighth lens;
the fifth lens is with positive refractive power, the sixth lens is with negative refractive power, the seventh lens is with positive refractive power, and the eighth lens is with negative refractive power;
the fifth lens, the sixth lens, the seventh lens, and the eighth lens are arranged in order from the object side to the image side along the optical axis;
the fifth lens is a biconvex lens and comprises a convex surface facing the object side and another convex surface facing the image side;
the sixth lens is a meniscus lens and comprises a concave surface facing the object side and a convex surface facing the image side;
the seventh lens is a meniscus lens and comprises a convex surface facing the object side and a concave surface facing the image side; and
the eighth lens is a meniscus lens and comprises a convex surface facing the object side and a concave surface facing the image side.

12. The optical system as claimed in claim 11, wherein the number of the lenses of the objective lens module is four.

13. The optical system as claimed in claim 11, wherein the fifth lens and the sixth lens are cemented, or there is no air gap between the fifth lens and the sixth lens.

14. The optical system as claimed in claim 1, further comprising an objective lens module, a prism module, and an eyepiece module, all of which are arranged in order from the object side to the image side along the optical axis, wherein:
the objective lens module, the prism module, and the eyepiece module are disposed between the optical module and the image side;
the eyepiece module comprises a ninth lens, a tenth lens, an eleventh lens, and a twelfth lens, wherein the ninth lens is with negative refractive power, the tenth lens is with positive refractive power, the eleventh lens is with positive refractive power, and the twelfth lens is with positive refractive power;
the ninth lens, the tenth lens, the eleventh lens, and the twelfth lens are arranged in order from the object side to the image side along the optical axis;
the ninth lens is a biconcave lens and comprises a concave surface facing the object side and another concave surface facing the image side;
the tenth lens is a biconvex lens and comprises a convex surface facing the object side and another convex surface facing the image side;
the eleventh lens is a meniscus lens and comprises a convex surface facing the object side and a concave surface facing the image side; and
the twelfth lens is a meniscus lens and comprises a convex surface facing the object side and a concave surface facing the image side.

15. The optical system as claimed in claim 14, wherein the number of the lenses of the eyepiece module is four.

16. The optical system as claimed in claim 14, wherein the ninth lens and the tenth lens are cemented, or there is no air gap between the ninth lens and the tenth lens.

17. The optical system as claimed in claim 1, further comprising an objective lens module, a prism module, and an eyepiece module, all of which are arranged in order from the object side to the image side along the optical axis, wherein:
the objective lens module, the prism module, and the eyepiece module are disposed between the optical module and the image side; and
the prism module comprises a first prism and a second prism and the prism module is an erect optical module.

18. The optical system as claimed in claim 17, wherein:
the objective lens module consists of four lenses with refractive power; and
the eyepiece module consists of four lenses with refractive power.

19. The optical system as claimed in claim 1, wherein the second lens is with negative refractive power and comprises a concave surface facing the object side and a plane surface facing the image side, or comprises a concave surface facing the object side and a concave surface facing the image side.
